(19) United States
(12) Patent Application Publication
(10) Pub. No.: US 2023/0106795 A1
(43) Pub. Date: Apr. 6, 2023

(54) PLUGIN RANKING SYSTEM AND METHOD FOR DATACENTER OPERATIONS MANAGEMENT

(71) Applicant: Dell Products, L.P., Round Rock, TX (US)

(72) Inventors: Pushkala Iyer, Round Rock, TX (US); Sudhir Vittal Shetty, Cedar Park, TX (US); Stephanos S. Heracleous, Leander, TX (US)

(73) Assignee: Dell Products, L.P., Round Rock, TX (US)

(21) Appl. No.: 17/492,897

(22) Filed: Oct. 4, 2021

(51) Int. Cl. G06F 9/445; G06F 11/34; G06F 11/32; G06F 11/30; G06N 20/00

(52) U.S. Cl. CPC G06F 9/44526; G06F 11/3409; G06F 11/324; G06F 11/3051; G06N 20/00; G06F 2201/86

(57) ABSTRACT

According to one embodiment, a plugin ranking system includes computer-executable instructions for use in a computing environment configured with multiple hardware components. The instructions may be executed to determine a collective operating characteristic of the hardware components, and rank the plurality of plugins according to a relevance of the management function of each plugin to the determined operating characteristic in which the plugins are each configured to perform a different management function for managing the computing environment. Once ranked, the instructions can then provide an indication of the ranked plugins for consumption by a user.

### FIELD

The present disclosure relates generally to Information Handling Systems (IHSs), and more particularly, to a plugin ranking system and method for datacenter operations management.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Modern day computing resources are provided by large computing environments that may include server farms, computer clusters, individual computing devices, and/or data centers. Computing environments are generally associated with large organizations, such as business enterprises to educational institutions such as universities. In many cases, larger organizations may manage multiple server farms over a diverse geographical region. Nevertheless, management of such large, diversified computing environments is typically provided by remotely configured system management consoles. OpenManage Enterprise is one example of a system management console provided by Dell Technologies, which cost-effectively facilitates comprehensive lifecycle management for the hardware components of distributed computing environments from one console.

These large computing environments have become an increasingly important aspect of the current economy. Among the advantages of such computing environments are their ability to handle a variety of different computing scenarios including large computational problems, high volume data processing situations, and high availability (HA) situations. Such distributed computing systems typically utilize numerous hardware components in support of the computing environment. Additionally, in an effort to aggregate such hardware components and to make them more manageable and flexible, systems managers are often used to coordinate the operation of such numerous devices.

### SUMMARY

According to one embodiment, a plugin ranking system includes computer-executable instructions for use in a computing environment configured with multiple hardware components. The instructions may be executed to determine a collective operating characteristic of the hardware components, and rank the plurality of plugins according to a relevance of the management function of each plugin to the determined operating characteristic in which the plugins are each configured to perform a different management function for managing the computing environment. Once ranked, the instructions can then provide an indication of the ranked plugins for consumption by a user.

According to another embodiment, a plugin ranking method includes the steps of determining a collective operating characteristic of multiple hardware components configured in a computing environment, and ranking multiple plugins according to a relevance of the management function of each plugin to the determined operating characteristic, and provide an indication of the ranked plugins for consumption by a user. Each of the plugins is configured to perform a different management function for managing the computing environment.

According to yet another embodiment, a systems manager appliance includes computer-readable instructions to determine a collective operating characteristic of a plurality of hardware components of a computing environment, rank a plurality of plugins according to a relevance of the management function of each plugin to the determined operating characteristic, and provide an indication of the ranked plugins for consumption by a user. Each of the plugins is configured to perform a different management function for managing the computing environment.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIG. 1 is a block diagram of examples of components of an Information Handling System (IHS) that may be used to implement a plugin ranking system and method according to one embodiment of the present disclosure.

FIG. 2 illustrates an example plugin ranking system that may be implemented on a computing environment according to one embodiment of the present disclosure.

FIG. 3 is a diagram view illustrating several components of an example plugin ranking system according to one embodiment of the present disclosure.

FIG. 4 illustrates a flowchart depicting certain steps of a plugin ranking method according to one embodiment of the present disclosure.

FIGS. 5A and 5B illustrate an example user interface window that may be generated by the systems manager to display ranked plugins according to one embodiment of the present disclosure.

### DETAILED DESCRIPTION

Embodiments of the present disclosure provide a plugin ranking system and method that ranks multiple plugins according to their relevance to certain operating characteristics exhibited by computing environments. Whereas traditional systems managers used to manage the operation of computing environments often did not possess capabilities of preferentially recommending certain plugins that would be most useful given the context in which a computing environment was being used, administrators could not reap the benefits that those plugins would have otherwise provided. Embodiments of the present disclosure provide a solution to this problem, among other problems, by monitoring the operation of the computing environment to identify one or more operating characteristics exhibited by the computing environment so that each of multiple plugins may be ranked according to their relevance to the identified operating characteristics. Given this valuable information, administrators would be appraised of a pertinent plugin such that they could install and use that plugin for enhanced task efficiency and ease of use. In some cases, administrators would be made aware of the plugin such that it may be implemented for use, while the tasks were being performed, thus furthering the enhanced efficiency afforded to those administrators.

Currently implemented computing environments, such as one implemented with a MX-7000 computing chassis provided by Dell Technologies, may include a large quantity of hardware components. For example, a fully scaled configuration of the MX-7000 may have up to 160 sleds and 24 I/O modules configured in 20 chassis. Furthermore each of the sleds is often configured with multiple individual hardware components. Management of a large, diversified computing environment such as this is typically provided by a remotely configured system management console commonly referred to as a systems manager. OpenManage Enterprise is one example of a systems manager provided by Dell Technologies, which cost-effectively facilitates comprehensive lifecycle management for the hardware components of IHSs from a single console. While such systems management consoles have been an effective tool for remotely managing a computing environment, their use with relatively large numbers of hardware components can sometimes become unwieldy.

The OpenManage Enterprise systems manager may be provided with numerous plugins. A plugin, which is also referred to as a plug-in, an add-on or add-in, generally includes an executable set of instructions that add a specific feature to an existing executable application. In essence, a plugin enables customization of the existing application for the user. Plugins offered for use with the OpenManage Enterprise includes a Power Manager Plugin (PMP), a Support Assist Plugin (SAEP), an Update Manager Plugin (UMP), a VMware Plugin (OMIVVP) just to name a few. In fact, new plugins that offer a specific functionality are continually being implemented at an ongoing basis to meet the varied needs of systems administrators.

Most or all plugins have heretofore been treated equally; that is, there has existed no platform or structure to provide or otherwise recommend certain plugins based upon the usage of the systems manager or the computing environment that it manages. Nonetheless, it would be desirable to encourage installation of some plugins for use by administrators. For one reason, it would be desirable to increase the attach rate of certain plugins for revenue generating purposes. For another reason, providing targeted plugin recommendations that are optimally suited to the customer environment would enhance customer satisfaction and user experience.

Conventional techniques for encouraging use of certain plugins by administrators have been considered. For example, plugin development streams could be integrated with the systems manager, or certain “preferred” plugins could be bundled with the systems manager releases. But such an arrangement could not take advantage of the independence of the plugins relative to the systems manager releases. Additionally, bundling those plugins with the systems manager software release would have an increased download binary size, thus impacting almost all users including those not interested in those bundled plugins. There would also be little or no flexibility for business re-prioritization of plugin importance without product complex marketing endeavors (e.g., customer advertising programs) that could be costly and difficult to manage. Thus, it would be advantageous to produce a product tailored to different customer environments. It is with these concerns in mind that embodiments of the present disclosure are provided herein.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, touchscreen and/or a video display. The IHS may also include one or more buses operable to transmit communications between the various hardware components.

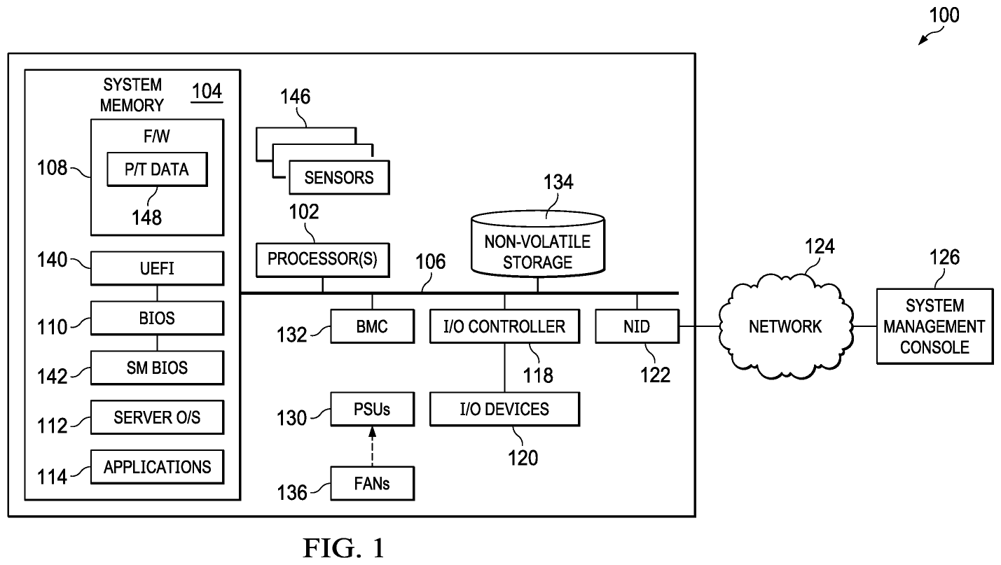

FIG. 1 is a block diagram of examples of components of an Information Handling System (IHS) that may be used to implement a plugin ranking system and method according to one embodiment of the present disclosure. Particularly, IHS 100 includes one or more processor(s) 102 coupled to system memory 104 via system interconnect 106. System interconnect 106 may include any suitable system bus. System memory 104 may include a plurality of software and/or firmware modules including firmware (F/W) 108, basic input/output system (BIOS) 110, operating system (O/S) 112, and/or application(s) 114. Software and/or firmware module(s) stored within system memory 104 may be loaded into processor(s) 102 and executed during operation of IHS 100.

F/W 108 may include a power/thermal profile data table 148 that is used to store power profile data and thermal profile data for certain hardware devices (e.g., processor(s) 102, system memory 104, non-volatile storage 134, NID 122, I/O controllers 118, etc.). System memory 104 may include a UEFI interface 140 and/or a SMBIOS interface 142 for accessing the BIOS as well as updating BIOS 110. In general, UEFI interface 140 provides a software interface between an operating system and BIOS 110. In many cases, UEFI interface 140 can support remote diagnostics and repair of computers, even with no operating system installed. SMBIOS interface 142 can be used to read management information produced by BIOS 110 of an IHS 100. This feature can eliminate the need for the operating system to probe hardware directly to discover what devices are present in the computer.

IHS 100 includes one or more input/output (I/O) controllers 118 which manages the operation of one or more connected input/output (I/O) device(s) 120, such as a keyboard, mouse, touch screen, microphone, a monitor or display device, a camera, a microphone, audio speaker(s) (not shown), an optical reader, a universal serial bus (USB), a card reader, Personal Computer Memory Card International Association (PCMCIA) slot, and/or a high-definition multimedia interface (HDMI), which may be included or coupled to IHS 100.

IHS 100 includes Network Interface Device (NID) 122. NID 122 enables IHS 100 to communicate and/or interface with other devices, services, and components that are located externally to IHS 100. These devices, services, and components, such as a system management console 126, can interface with IHS 100 via an external network, such as network 124, which may include a local area network, wide area network, personal area network, the Internet, etc.

For the purposes of this disclosure, the term “system management console” may refer broadly to systems that are configured to couple to a management controller and issue management instructions for an information handling system (e.g., computing device) that is being managed by the management controller. One example of such a system management console is the Dell OpenManage Enterprise (OME) systems management console. In various embodiments, management consoles may be implemented via specialized hardware and/or via software running on a standard information handling system. In one embodiment, a system management console may be deployed on a secure virtual machine (VM), such as a VMWARE Workstation appliance.

IHS 100 further includes one or more power supply units (PSUs) 130. PSUs 130 are coupled to a BMC 132 via an I²C bus. BMC 132 enables remote operation control of PSUs 130 and other components within IHS 100. PSUs 130 power the hardware devices of IHS 100 (e.g., processor(s) 102, system memory 104, non-volatile storage 134, NID 122, I/O controllers 118, etc.). To assist with maintaining temperatures within specifications, an active cooling system, such as one or more fans 136 may be utilized.

IHS 100 further includes one or more sensors 146. Sensors 146 may, for instance, include a thermal sensor that is in thermal communication with certain hardware devices that generate relatively large amounts of heat, such as processors 102 or PSUs 130. Sensors 146 may also include voltage sensors that communicate signals to BMC 132 associated with, for example, an electrical voltage or current at an input line of PSU 130, and/or an electrical voltage or current at an output line of PSU 130.

BMC 132 may be configured to provide out-of-band management facilities for IHS 100. Management operations may be performed by BMC 132 even if IHS 100 is powered off, or powered down to a standby state. BMC 132 may include a processor, memory, and an out-of-band network interface separate from and physically isolated from an in-band network interface of IHS 100, and/or other embedded resources.

In certain embodiments, BMC 132 may include or may be part of a Remote Access Controller (e.g., a DELL Remote Access Controller (DRAC) or an Integrated DRAC (iDRAC)). In other embodiments, BMC 132 may include or may be an integral part of a Chassis Management Controller (CMC).

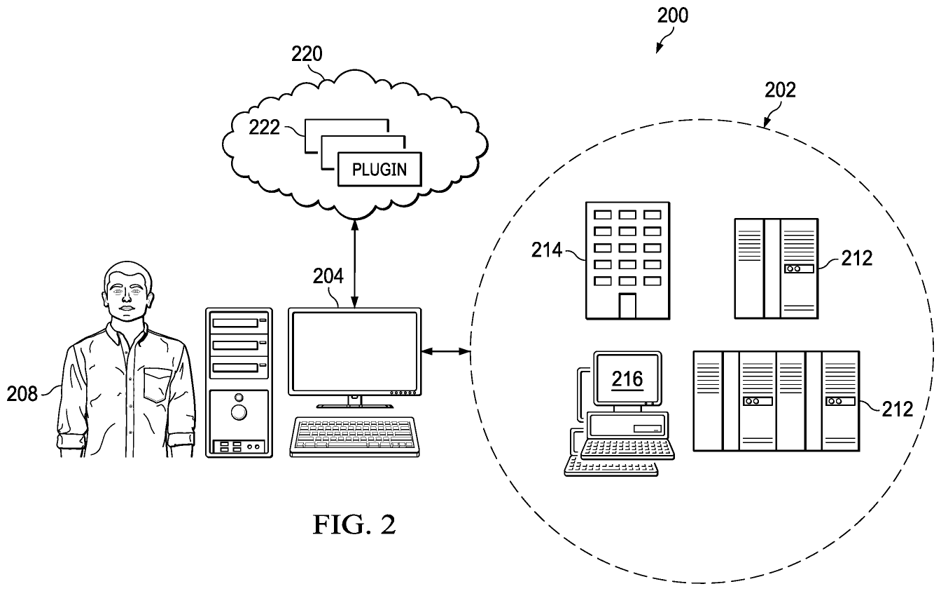

FIG. 2 illustrates an example plugin ranking system 200 that may be implemented on a computing environment according to one embodiment of the present disclosure. The plugin ranking system 200 generally includes a computing environment 202 that is managed by a systems management appliance 204. The plugin ranking system 200 also includes an online support site 220 that may be accessed for, among other things, serving various plugins 222 for use by the systems manger appliance 204. As shown, the systems management appliance 204 communicates with the computing environment 202 and the support site 220 through a publicly accessible network, such as the Internet. Nevertheless, it should be appreciated that the systems management appliance 204 may communicate locally with the computing environment 202, or form a part of the computing environment 202.

In general, the systems management appliance 204 is configured to monitor and control any number of computing devices in the computing environment 202. In one embodiment, the systems management appliance 204 provides at least a portion of the features of the systems management console 126 described herein above. The computing environment 202 may include any type and quantity of hardware components, such as those that may be included in a computing cluster 212, a data center 214, or multiple computing devices 216 of an organizational entity, such as a business, or school. In one embodiment, the computing environment 202 includes multiple hardware components that may be similar in design and construction to the IHS 100 described above with reference to FIG. 1.

Computing environment 202 may be one managed by a single entity, such as a vendor of the computing devices, or some other large organization having a first computing cluster 212 located in Dallas, Tex., a second computing cluster 212 located in Houston, Tex., a data center 214 located in Atlanta, Ga., and multiple computing devices 216 located in their home office in Austin, Tex. Thus, the number and type of computing devices managed by the systems management appliance 204 can, and often does, vary widely across the computing environment 202 that it is designed to manage.

It would be useful for administrators of the systems manger appliance 204 to have ready access to certain tools most relevant to the task being currently performed. For example, it would be useful for an administrator to have access to certain power management tools when the computing environment 202 experiences power related problems over an extended period of time, or access to certain software updating tools when software update procedures require an unduly large amount of effort to complete. In many cases, power management tools and software updating tools exist for the systems manger appliance 204 in the form of plugins 222 that can be readily downloaded and installed on the systems manger appliance 204, but admins may not be aware of their existence, or even how to have such tools downloaded and installed. Additionally, certain conditions may exist in the computing environment 202 that its administrator may not be aware of in which those conditions could be more effectively dealt with using a certain plugin 222.

Embodiments of the present disclosure provide a solution to these problems by monitoring a combination of factors of the computing environment 202, such as a feature usage of the computing environment 202, a current inventory of the hardware components configured in the computing environment 202, any ongoing alert conditions, as well as any business priorities that the administrator may be particularly sensitive to, and ranking the available plugins 222 such that those plugins most ideally suited for the challenges are presented to the admins in ranked form.

Support site 220 may be a vendor support site or a third party original equipment manufacturer (OEM) support site. The support site 220 may include a server and a persistent memory where plugins 222 and updates are persisted such as update catalog and/or and update package. In a particular embodiment, the server can be a file server, a database server, or the like. The persistent memory can include one or more disk drives or other suitable persistent memory. If the server is a database server, then the plugins 222 within the repository can be organized as a database. If the server is a file server, the file server can locate an appropriate plugin 222 corresponding to the update and send it to the systems manager appliance 204. The support site 220 may be located locally on-premise or remotely from the computing environment 202.

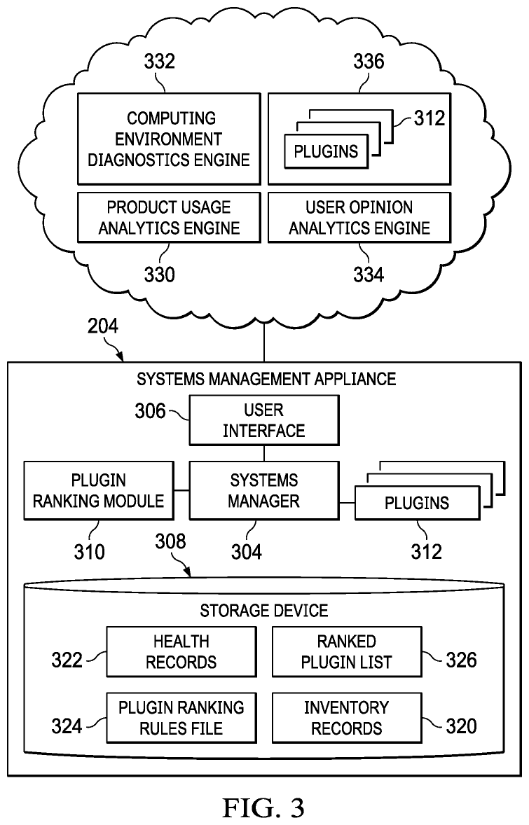

FIG. 3 is a diagram view illustrating several components of an example plugin ranking system 300 according to one embodiment of the present disclosure. The plugin ranking system 300 includes a systems management appliance 204 installed with a systems manager 304, a user interface 306, a storage device 308, a plugin ranking module 310, and one or more plugins 312 that have been previously downloaded and installed for use with the systems manager 304. In one embodiment, the user interface 306 may provide at least a portion of the features of the systems management console 126 described herein above. The systems manager 304 monitors and controls the operation of various hardware components, such as those configured in a computing environment 200 as described above with reference to FIG. 2. One particular systems manager 304 may be, for example, a Dell EMC OpenManage Enterprise (OME) that is installed on a secure virtual machine (VM), such as a VMWARE Workstation.

Storage device 308 stores inventory records 320, health records 322, a plugin ranking rules file 324, and a ranked plugin list 326. The inventory records 320 generally include information about the hardware components configured in the computing environment 202. Such information may include, for example, the quantity and type (e.g., make and model) of the hardware components configured in the computing environment 202, and how those hardware components are configured (e.g., installed software, installed hardware, component settings, number of processing cores, memory capacity, number and type of I/O ports, BIOS settings, etc.). In one embodiment, the inventory records 320 are each associated with a hardware component configured in the computing environment 202 in which each computing device record includes information about its associated hardware component.

Heath records 322 store information about the health of the computing environment 202. For example, the health records 322 may store information about alerts (e.g., warnings, failures, errors, etc.) along with their severity that have been generated during the use of the computing environment 202. The alerts may be based on individual hardware components, a portion of the computing environment 202 (e.g., a sled, a computing rack, a chassis, etc.), or they may be based on an overall cumulative health of the computing environment 202. As will be described in detail herein below, the plugin ranking system 300 may use the health records 322 to identify problem areas in the computing environment 202, and rank available plugins according to their relevance to operating characteristics of the computing environment 202.

The plugin ranking system 300 may use various cloud-based services, such as a product usage analytics engine 330, a computing environment diagnostics engine 332, a user opinion analytics engine 334, and a plugin catalog 336. The plugin catalog 336 stores various plugins 312 that are available for use with the systems manager 304. For example, the plugin catalog may store a diagnostic tool plugin, such as a Support Assist Plugin (SAEP) provided by Dell Technologies, that functions with the computing environment diagnostics engine 332 to perform various diagnostics operations on the hardware components of the computing environment 202. The plugin catalog 336 may also store a software update manager plugin (UMP) that functions with the systems manager 304 to assist the user with downloading and installing software, such as the plugins stored in the plugin catalog 336 or even a newer version of the systems manager 304. Other available plugins may include a power manager plugin that provides a management function of managing the power sources used to power the computing environment 202, and a virtual machine management plugin (e.g., a VMware Plugin (OMIVVP) provided by Dell Technologies) that provides a management function of managing hypervisors (e.g., VMWare ESXi hypervisor) implemented in the computing environment 202. Although a short list of available plugins are described herein above, it should be appreciated that other plugins adapted for providing different management functions may exist without departing from the spirit and scope of the present disclosure. Additionally, as can be readily seen, each plugin may provide a particular management function for assisting the user with managing the operation of the computing environment 202.

The plugin ranking module 310 ranks available plugins stored in the plugin catalog 336 according to a relevance of the management function of each plugin to an operating characteristic of the computing environment 202. An operating characteristic generally refers to a particular aspect exhibited by the computing environment 202 during its operation. One example operating characteristic may include a power-based operating characteristic in which the systems manager 304 spends a relatively long time dealing with power related issues, such as power outages, power source failures, and the like. Another power-based operating characteristic may include detecting that the user spends substantial time managing power related issues. Other operating characteristics may include detecting that the user spends a relatively long time performing software updates to the hardware components of the computing environment 202, detecting that the user spends a relatively long time diagnosing problems, or detecting relatively large amounts of hypervisor management. In some cases, the operating characteristic may be based on a desired business goal for the computing environment 202. For example, the administrator may advertise a certain level of reliability (e.g., up-time) to its potential customers; as such, a weighting value may be assigned to certain plugins so that the computing environment 202 or a designated portion of the computing environment 202 may be maintained at its advertised level of reliability.

The plugin ranking module 310 may determine the operating characteristic using several different factors. In one embodiment, the plugin ranking module 310 may determine the operating characteristic according to an inventory of the computing environment 202. For example, the plugin ranking module 310 upon examining the inventory records 320, may detect that large amounts of hypervisor management is being conducted. As such, the plugin ranking module 310 may increase a weighting factor to be applied to the virtual machine management plugin (e.g., Dell's OMIVVP plugin) so that its ranking can be increased. As another example, the plugin ranking module 310 may examine the inventory records 320 and determine that the power supplies used to power certain hardware components are operating with minimal redundancy. As such, the plugin ranking module 310 may increase a weighting factor to be applied to the power manager plugin (e.g., Dell's PMP plugin) so that its ranking can be increased.

In another embodiment, the plugin ranking module 310 may determine the operating characteristic according to a health of the computing environment 202. For example, the plugin ranking module 310 may examine the health records 322 and detect that the computing environment 202 or certain hardware components in the computing environment 202 are experiencing an inordinately large amount of failures. In such a case, the plugin ranking module 310 may increase a weighting factor to be applied to the diagnostics plugin (e.g., Dell's SAEP plugin) so that its ranking can be increased.

In yet another embodiment, the plugin ranking module 310 may determine the operating characteristic according to analytics provided by the product usage analytics engine 330. Product usage refers to certain levels in which a hardware component or a group of hardware components in the computing environment 202 are used. In one embodiment, the product usage may be based on the usage levels of multiple computing environments 202. For example, a hardware component vendor who provides hardware components to numerous users, may implement a cloud-based product usage analytics engine 330 that continually monitors the usage of each of those numerous users and combines the monitored usage patterns to provide a cumulative operating characteristic that may be used to rank the plugins.

The plugin ranking module 310 may function with certain cloud-based tools to rank plugins according to their relevance to the operating characteristics of a computing environment 202.

According to embodiments of the present disclosure, the plugin ranking module 310 and/or the cloud-based tools executes one or more artificial intelligence (AI) services to rank the plugins used by the systems manager 304. In general, the plugin ranking module 310 along with the product usage analytics engine 330 gathers telemetry data from the hardware components of one or more computing environments 202 such as CPU resources, GPU resources, storage resources, communication resources (e.g., Ethernet, USB, etc.), software resources (e.g., operating system (OS), one or more applications executed on the hardware components, drivers, etc.), and various platform resources (e.g., communication systems, peripheral devices, power/thermal control systems, etc.), along with sensors 146 to characterize their resource utilization. For example, the product usage analytics engine 330 may generate one or more performance features from telemetry data gathered from such resources to generate one or more profiles associated with the usage of each hardware component. Once the product usage analytics engine 330 has collected characteristics over a period of time, it may then process the collected data using statistical descriptors to extract the usage levels of those hardware components. For example, the product usage analytics engine 330 may monitor the hardware component resources over time to estimate its resource usage with respect to various aspects, such as which actions performed by IHS 100 cause certain resources to encounter loading, and a time period of day in which these actions are encountered.

Once the product usage analytics engine 330 has collected characteristics over a period of time, it may then process the collected data using statistical descriptors to extract the usage levels associated with each hardware component. From these usage levels, the product usage analytics engine 330 may categorize certain hardware components according to their type so that usage levels for each type of hardware component can be obtained. The product usage analytics engine 330 may use any suitable AI-based learning algorithm such as, for example, a Bayesian algorithm, a Linear Regression algorithm, a Decision Tree algorithm, a Random Forest algorithm, a Neural Network algorithm, or the like.

As shown, the product usage analytics engine 330 is a cloud provided service in which it communicates through a publicly available communication network, such as the Internet, to communicate with the plugin ranking module 310. In one embodiment, the product usage analytics engine 330 may be provided as a subscription service, in which users and/or administrators of the computing environments 202 may register for such services. Although the product usage analytics engine 330 is described and shown as a cloud-based service, other embodiments contemplate that the product usage analytics engine 330 may be stored and executed on the computing environment 202 it is configured to services for. For example, the product usage analytics engine 330 may be stored and executed on the systems management appliance 204.

The computing environment diagnostics engine 332 and user opinion analytics engine 334 are generally similar in design and construction to the product usage analytics engine 330. The user opinion analytics engine 334 differs, however, in that it receives and stores crowd based input regarding user opinions about how well certain plugins or liked or disliked, and based upon the crowd based input, generates weighting factors to each of the plugins based on how well they are liked by users. The computing environment diagnostics engine 332 also differs in that it receives and stores information about any diagnostics performed on the hardware components of each computing environment 202, and based on the received information, generates weighting factors to certain plugins according to their relevance to the type of diagnostics being performed. For example, the computing environment diagnostics engine 332 may work in conjunction with a cloud-based diagnostic support tool, such as the CloudIQ SupportAssist online diagnostic support tool from Dell Technologies, to gather information about which problems are most prevalent in the field.

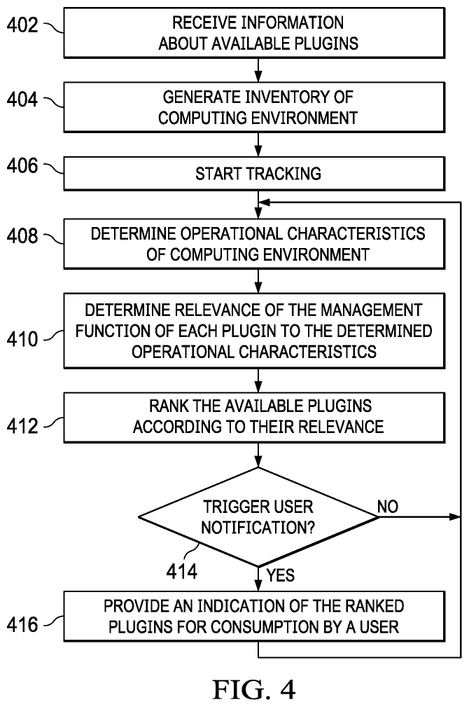

FIG. 4 illustrates a flowchart depicting certain steps of a plugin ranking method 400 according to one embodiment of the present disclosure. In one embodiment, at least a portion of the steps of the method 400 may be performed by the plugin ranking module 310 executed on the systems manager appliance 204. In another embodiment, certain steps of the method 400 may be performed by the product usage analytics engine 330, computing environment diagnostics engine 332, user opinion analytics engine 334 either independently or in combination with the plugin ranking module 310. Although the method 400 describes certain steps for ranking multiple available plugins according to their management function relative to an operating characteristic of a computing environment 202 managed by the systems manager 304, it should be appreciated that the method 400 may be performed using other operating characteristics not explicitly described herein without departing from the spirit and scope of the present disclosure.

Initially, a plugin ranking rules file 324 is generated that includes rules associated with how certain weighting factors for each plugin are to be applied. For example, the user may populate the plugin ranking rules file 328 with rules associated with a business objective for how the plugins are ranked. For example, a business objective of increasing an attach rate for a particular plugin may involve receiving user input for increasing a weighting factor for a certain plugin such that it will be ranked relatively higher than the other plugins. Additionally, the computing environment 202 is started (e.g., turned-up) and each of the hardware components placed in service, such as being configured with certain end-use applications, coupled to a communications network, and booted to commence their operation.

Initially at step 402, the method 400 receives information about available plugins that are adapted for use with the systems manager 304. The plugin ranking module 310 may, for example, query the plugin catalog 336 to obtain a list of plugins 312. In one embodiment, each plugin may include a tag that stores information about its particular management function. For example, a power management plugin may include a tag indicating it has a power intensive management function, while a diagnostic management plugin may include a tag indicating it has a diagnostic intensive management function. Some plugins may have more than one management function. For example, a diagnostic plugin, such as the SAEP plugin, may have a diagnostic intensive management function as well as a storage intensive management function due to its ability to perform diagnostic services as well as service storage units in the computing environment 202. The method 400 also generates inventory records 320 of the computing environment 202 at step 404. In one embodiment, the IHS inventory 320 may be generated according to a discovery process. Once generated, the inventory records 320 include information about a configuration of the hardware components and any other support components (e.g., lighting facilities, cooling units, security systems, fire prevention devices, etc.) of the computing environment 202.

At step 406, the method 400 starts tracking the operation of the hardware components of the computing environment 202. In one embodiment, the method 400 may perform a ML process to determine operating characteristics of the computing environment 202 that may then be used to rank the plugins according to their relevance to the operation of the computing environment 202. For example, the method 400 may record characteristics derived from each or certain ones of the cloud-based tools (e.g., product usage analytics engine 330, computing environment diagnostics engine 332, and/or user opinion analytics engine 330) and perform its own ML process against the data to derive one or more operating characteristics of the computing environment 202.

As noted above, plugin ranking module 310 may continually or periodically communicate with the product usage analytics engine 330, computing environment diagnostics engine 332, and/or user opinion analytics engine 334 to gather data over an ongoing period of time, and use the gathered data to characterize one or more operational characteristics of the computing environment 202 and rank available plugins stored in plugin catalog 336 according to those operating characteristics. In various implementations, method 400 may be used to adaptively manage the various characterizations, learning, and/or optimization techniques performed by plugin ranking module 310 and/or cloud-based tools by ranking the plugins by order of relevance, which takes into account information processed by the product usage analytics engine 330, computing environment diagnostics engine 332, and/or user opinion analytics engine 334. In one embodiment, the plugin ranking module 310 classifies the hardware components of the computing environment 202 according to one or more operating characteristics (e.g., a power intensive operating characteristic, a software update intensive operating characteristic, a diagnostic intensive operating characteristic, a hypervisor intensive operating characteristic, etc.). Although only a product usage analytics engine 330, computing environment diagnostics engine 332, and/or user opinion analytics engine 334 based tools are shown and described herein, it should be appreciated that other tools, including other cloud-based tools or non cloud-based tools may exist. Thereafter at step 408, method 400 may compute a score for each of the determined operational characteristics of the computing environment 202.

At step 410, method 400 determines a relevance of the management function of each plugin to the determined operational characteristics. In one embodiment, the plugin ranking module 310 may apply any rules stored in the plugin ranking rules file 324 to the plugins. The plugin ranking rules file 324 may also include conditional clauses that dictate how and when a certain rule is applied. For example, the plugin ranking rules file 324 may include a conditional clause indicating that a rule is to be applied only when the computing environment 202 is comprised of multiple facilities (e.g., data centers) distributed over a relatively large geographical region. As another example, the plugin ranking rules file 324 may include another conditional clause indicating that another rule is to be applied when the computing environment 202 includes certain hardware components. Thereafter, the method 400 ranks the available plugins according to their relevance, and stores the ranking in the ranked plugin list 326 at step 412.

At step 414, the method 400 determines whether or not a user indication of the plugin ranking should be issued. The determination may be based on user input (e.g., specific user request) or based upon a triggering event that occurs. For example, the user indication may be triggered as a result of a relatively large number of software update events occurring within the computing environment 202. In such a case, the plugin ranking module 310 may detect the large number of software update events and in response, generate a pop-up screen indicating that a software update plugin is available for download.

Nevertheless, if no user indication is to be issued, processing continues at step 408 to continue gathering data about the computing environment 202, and processing the gathered data for continued updating of the ranked plugin list 326. If, however, a user indication is to be issued processing continues at step 416.

At step 416, the method 400 provides an indication of the ranked plugins for consumption by a user. The indication may be provided in any suitable manner. In one embodiment, the method 400 may display the indication on a user interface for view by the user. In another embodiment, the method 400 may generate and send an e-mail message including the indication to the user. The indication may include a ranked list of all available plugins, or it may include information associated with one or a few of the available plugins. For example, when the method 400 detects certain activity occurring with the systems manager 304, it may present only a single plugin adapted to assist in performing that detected activity.

The heretofore described method 400 is continually performed during the operation of the systems manager 304 for continually updating the ranked plugin list 326 according to ongoing changes that occur with the computing environment 202. Nevertheless, when use of the method 400 is no longer needed or desired, the method 400 ends.

Although FIG. 4 describes one example of a process that may be performed by the plugin ranking module 310 for ranking plugins used to function with a systems manager 304, the features of the disclosed process may be embodied in other specific forms without deviating from the spirit and scope of the present disclosure. For example, the method 400 may perform additional, fewer, or different operations than those operations as described in the present example. As another example, the steps of the process described herein may be performed by another computing system other than systems manager appliance 204, such as by one or more hardware components configured in the computing environment 202. As yet another example, the sequence in which steps of the aforedescribed process may be performed should not be limited thereto as it is contemplated that in other embodiments, the disclosed steps may be performed in a different order or sequence without departing from the spirit and scope of the present disclosure.

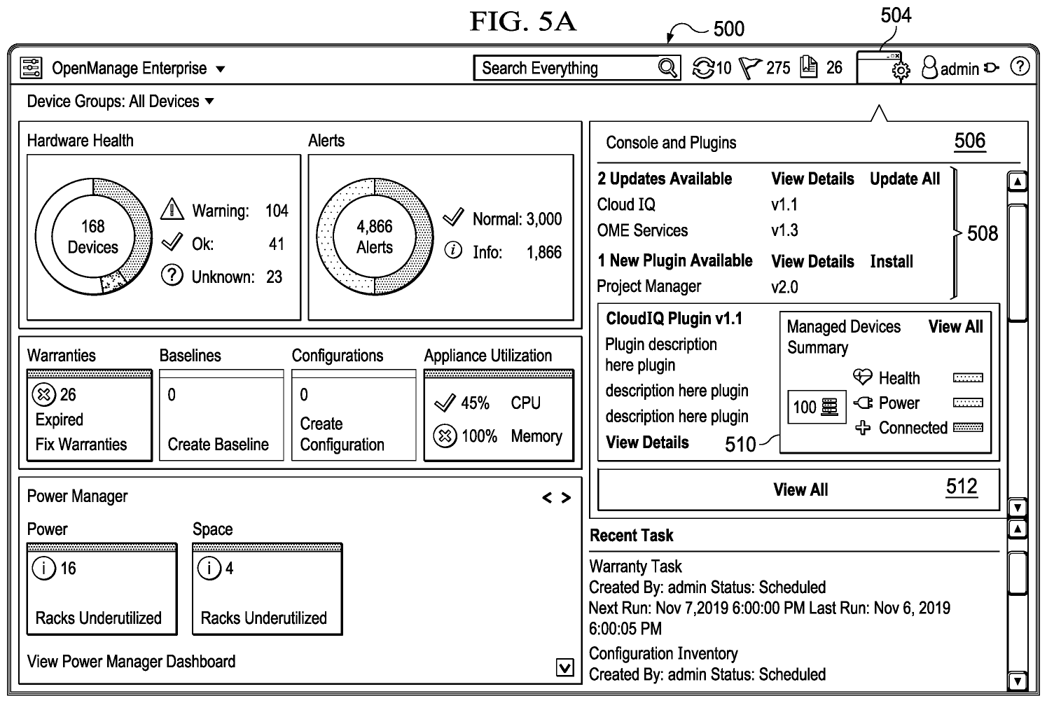

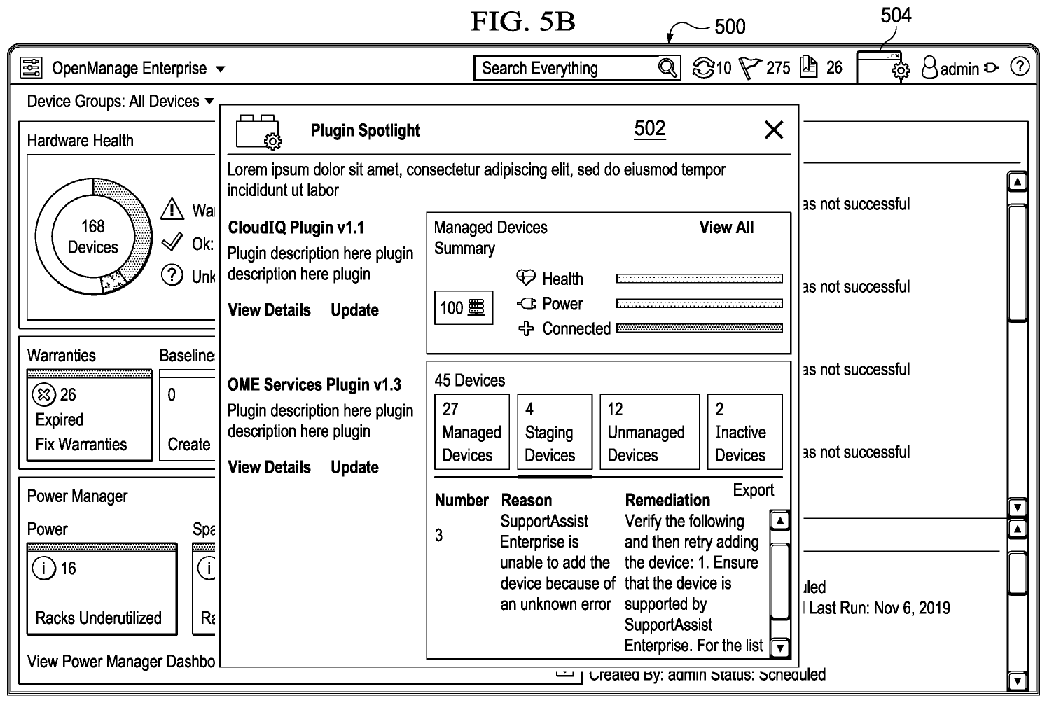

FIGS. 5A and 5B illustrate an example user interface window 500 that may be generated by the systems manager 304 to display ranked plugins according to one embodiment of the present disclosure. In particular, FIG. 5A illustrates an example user interface window 500 during normal operation of the systems manager 304, while FIG. 5B illustrates the example user interface window 500 with an additional popup screen 502 that has been generated by the systems manager 304 for displaying information about certain plugins that may be available for use with the systems manager 304.

In general, the user interface window 500 provides information about the operation of the computing environment 202 that it manages. Among other things, the user interface window 500 includes a selectable icon 504 that when selected by the user, displays a plugins information window 506 that shows summary information for currently installed plugins 508 as well as a ranked plugin 510 that has been selected to be displayed by the plugin ranking module 310. In this particular case, summary information about a cloud-based plugin is displayed along with a selectable plugin details button 512.

When the plugin details button 512 is selected by the user, the systems manager 304 displays the popup screen 502. The popup screen 502 provides additional details about the ranked plugin, which is in this particular case the cloud-based plugin. In one embodiment, the additional details may include information about how the ranked plugin may provide enhanced benefit for the operation or operations currently being performed by the user. The additional details may also include information about how the ranked plugin may benefit the user based upon the current operating state of the computing environment 202 as determined by the plugin ranking module 310.

Thus as can be seen, the plugin ranking system may provide for enhanced operation of the systems manager 304 by determining one or more operating characteristics of the computing environment 202 so that multiple plugins can be ranked and a relevant plugin advertised to a user. Moreover, this process can be conducted in real-time so that the relevant plugin can be advertised as the user is performing those tasks that could be associated with the determined operating characteristics of the computing environment 202.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A plugin ranking system comprising:
a computing environment comprising a plurality of hardware components; and
a plurality of plugins each configured to perform a different management function for managing the computing environment; and
computer-readable instructions stored in at least one memory and executed by at least one processor to:
determine a collective operating characteristic of the hardware components;
rank the plurality of plugins according to a relevance of the management function of each plugin to the determined operating characteristic; and
provide an indication of the ranked plugins for consumption by a user.

2. The plugin ranking system of claim 1, wherein the instructions are further executed to determine the collective operating characteristics using a machine learning (ML) process.

3. The plugin ranking system of claim 1, wherein the instructions comprise a systems manager configured to manage the operations of the computing environment.

4. The plugin ranking system of claim 1, wherein the indication comprises a popup window that is displayed on a display.

5. The plugin ranking system of claim 4, wherein the instructions are further executed to display the popup window in response to a triggering event that occurs on the computing environment.

6. The plugin ranking system of claim 1, wherein the instructions are further executed to determine the collective operating characteristics using a crowd sourced input.

7. The plugin ranking system of claim 1, wherein the instructions are further executed to determine the collective operating characteristics using a cloud-based tool.

8. The plugin ranking system of claim 1, wherein the instructions are further executed to determine the collective operating characteristics according to one or more rules, wherein the rules are editable by a user.

9. The plugin ranking system of claim 1, wherein the instructions are further executed to determine the collective operating characteristics according to at least one of a feature usage level of the hardware components of the computing environment, a level of alerts generated by the hardware components, an identified purpose for the hardware components in the computing environment, an inventory of the computing environment, and a usage level of other computing environments.

10. A plugin ranking method comprising:
determining, using instructions stored in at least one memory and executed by at least one processor, a collective operating characteristic of a plurality of hardware components configured in a computing environment;
rank a plurality of plugins according to a relevance of the management function of each plugin to the determined operating characteristic, each of the plugins configured to perform a different management function for managing the computing environment; and
provide an indication of the ranked plugins for consumption by a user.

11. The plugin ranking method of claim 10, further comprising determining the collective operating characteristics using a machine learning (ML) process.

12. The plugin ranking method of claim 10, further comprising displaying the popup window in response to a triggering event that occurs on the computing environment, wherein the indication comprises a popup window that is displayed on a display.

13. The plugin ranking method of claim 10, further comprising determining the collective operating characteristics using a crowd sourced input.

14. The plugin ranking method of claim 10, further comprising determining the collective operating characteristics using a cloud-based tool.

15. The plugin ranking method of claim 10, further comprising determining the collective operating characteristics according to one or more rules, wherein the rules are editable by a user.

16. The plugin ranking method of claim 10, further comprising determining the collective operating characteristics according to at least one of a feature usage level of the hardware components of the computing environment, a level of alerts generated by the hardware components, an identified purpose for the hardware components in the computing environment, an inventory of the computing environment, and a usage level of other computing environments.

17. A systems manager appliance comprising:
computer-readable instructions stored in at least one memory and executed by at least one processor to:
determine a collective operating characteristic of a plurality of hardware components of a computing environment;
rank a plurality of plugins according to a relevance of the management function of each plugin to the determined operating characteristic, each of the plugins configured to perform a different management function for managing the computing environment; and
provide an indication of the ranked plugins for consumption by a user.

18. The systems manager appliance of claim 17, wherein the instructions are further executed to determine the collective operating characteristics using a machine learning (ML) process.

19. The systems manager appliance of claim 17, wherein the instructions are further executed to display a popup window in response to a triggering event that occurs on the computing environment, wherein the indication comprises the popup window that is displayed on a display.

20. The systems manager appliance of claim 17, wherein the instructions are further executed to determine the collective operating characteristics using a cloud-based tool.
